(19) United States
(12) Patent Application Publication
(10) Pub. No.: US 2011/0089013 A1
(43) Pub. Date: Apr. 21, 2011

(54) Apparatus of produced water treatment, system and method of using the apparatus, and method of water reuse by using the same

(76) Inventors: Masaaki Sakurai, Narashino-shi (JP); Hiroaki Ikebe, Narashino-shi (JP); Hiroshi Yokohata, Narashino-shi (JP); Toru Morita, Osaka (JP); Kiyoshi Ida, Osaka (JP)

(21) Appl. No.: 12/924,291

(22) Filed: Sep. 24, 2010

(30) Foreign Application Priority Data
Oct. 16, 2009 (JP) 2009-239857

(51) Int. Cl. C02F 1/44; B01D 65/02; C02F 1/04

(52) U.S. Cl. 201/2; 210/409; 210/137; 210/196; 210/134; 210/194; 210/179; 202/197; 210/636

(57) ABSTRACT

An apparatus of produced water treatment, to be adopted in an in-situ recovery method of producing bitumen from oil sand, the apparatus capable of removing the oil from produced water, the produced water of being left by separating the bitumen from bitumen-mixed fluid having been recovered from the oil sand, the apparatus having: a vessel for receiving the produced water; a submerge type filtration membrane module, installed in the vessel, for filtering the produced water in the condition of the membrane being submerged in the produced water; and a bubble generator for generating bubbles to be forwarded toward the submerged filtration membrane in the produced water.

### FIELD OF THE INVENTION

The present invention relates to apparatus of produced water treatment to be adopted in an in-situ recovery method of producing bitumen from oil sand, to a system and a method of using the apparatus, and to a method of water reuse by using the same.

### BACKGROUND OF THE INVENTION

Bitumen recovered from oil sands as one of petroleum resources has been regarded only as a preliminary or alternative resource for the next generation until now. Even though the bitumen itself is inferior in quality, products obtained from the bitumen however have strong competitiveness to those obtained from crude oil. Further, a possibility of the bitumen as an alternative of the crude oil is also rising from a viewpoint of cost. Besides, Canadian oil sands have a good reputation for their overwhelming reserve that is almost equal to that of Saudi Arabia's crude oil. For example, the hydrocarbon reserve in Alberta State and its neighbor area in Canada is one of the largest reserves in the world. Above all, different from geopolitically unstable area such as Middle East and African countries, Canada has extremely low investment risks. To ensure a stable energy supply is extremely important tasks for resource-poor Japan and any other countries. From this point of view, therefore, Canada has been ranked as a current supply area of valuable petroleum resources.

In the production of bitumen from the oil sands, recently, the bitumen located at depths in which development by surface mining is difficult to conduct, has gotten much attention. As a method capable of realizing recovery of bitumen from oil sands located at the depths, the in-situ recovery method attracts attention, such as the SAGD (steam assisted gravity drainage) process and the CSS (cyclic steam stimulation) process. Thus, a technical development of the in-situ recovery method has been energetically advanced (see “Development of Canada oilsands—Future challenges”, Kiyoshi Ogino, Journal of the Japanese Association for Petroleum Technology, Vol. 69, No. 6 (November 2004) pp. 612-620).

According to the in-situ recovery method, a high-temperature steam is injected into high viscosity oil in an oil sand layer, in which the oil is not able to flow at a normal temperature. The viscosity of oil is reduced by heat. Resultantly, aggregated high-temperature condensate and oil are recovered by the steam injection. Therefore, “water” for producing a large amount of high-temperature steam is required. In order to produce a steam, for example, the SAGD process described below uses water of about three times as much as the amount of oil to be produced. Meanwhile, in Canada, quantity of water intake that is allowed to use is limited by the severe environmental policies (regulation) in the states, and effluent-injecting layers having a sufficient capacity are not located in the neighbor area. Therefore, water recycling shall be applied (see “Water recycling for oil sands development”, Nobutoshi Shimizu and Tsuneta Nakamura, Journal of the Japanese Association for Petroleum Technology, Vol. 70, No. 6 (November 2005) pp. 522-525).

In order to recycle water used for the production of the bitumen, the following methods have been used infra. Firstly, flow of a conventional method is explained (see FIGS. 4 and 5). The bitumen-mixed fluid 20A recovered from the earth (oil sand layers 1) in the in-situ recovery method is sent to a free water knockout 2. The treated liquid including bitumen treated herein is sent to the feeding direction d₁ and further treated with a treater 3, and then cooled with a cooler 51. The cooled bitumen is stored in an oil storage tank 4. The bitumen (product) may be shipped from here according to the demand. The mark*A shown in FIGS. 4 and 5 indicates a connecting position of them, i.e, these figures are connected to each other at the position marked by the *A.

On the other hand, an oil-containing water (which may be referred to as a “produced water”) 20 B separated by the free water knockout 2 is sent to the feeding direction d₂. The produced water 20 B is cooled with a cooler 51 to a predetermined temperature, and then moved into the skim tank 5. At this time, a part of the produced water is also separated from the treater 3 and moved into the skim tank 5 (see the feeding direction d₂′). Further, the process gas is also separated from the bitumen-mixed fluid in the free water knockout 2 and the treater 3. The gas is sent from these apparatuses to the gas scrubber (not shown in the figures) for treating it as fuel gas. The oil in the produced water is separated and removed from it by the skim tank 5, the induced gas flotation 6 and the oil removal filter 7 using, for example, walnut shells, and the de-oiled produced water is stored in the deoiled tank 8, whereby a treated water 20 D′ of a conventional process is recovered (the conventional treated water is referred to as 20 D′ in order to distinguish from the treated water 20 D according to the present invention described below). The oil-water separation according to this method is basically gravity separation in which a difference in specific gravity between oil and water is used. In FIG. 4, the temperature and/or oil content are shown in the box. These values are typical ones, but the present invention should not be construed to a limited extent with reference to these specific temperatures and concentrations.

At the subsequent stage, a hardness component is removed from the treated water 20 D′ by the lime softener 9 and the weak acid cation softener 11. The resultantly-treated water is stored in the boiler feed water tank 13 and supplied from the tank to the once-through-type boiler (not shown in the figure) as a boiler feed water 20 C. A steam produced in this boiler is used again for the recovery of bitumen from an oil sand layer Recently, it is not a rare case that pure water is produced by means of the evaporator 12 which is a mechanical vapor compression type (including a compression cycle 14 and a compressor 52), as one of desalination process in place of a softening treatment in the above-described process d₁₂, and the thus-produced water is fed to a general-purpose drum-type boiler (not shown in the figure) as a boiler feed water 20 C (see the process d₁₃ in FIG. 5).

In the conventional flow, however, a number of equipments and steps are required for oil-water separation, which results in a troublesome operation and a high cost of equipment with a difficult operation and maintenance. Further, there is reported a case example in which organic scales deposit in a heat exchanger and a boiler, thereby causing corrosion cracking due to thermal stress (see “Water recycling for oil sands development”, Nobutoshi Shimizu and Tsuneta Nakamura, Journal of the Japanese Association for Petroleum Technology, Vol. 70, No. 6 (November 2005) pp. 522-525). It is assumed to be a primary cause that though oil droplets of relatively large particle size can be separated, oil droplets of small particle size or emulsified oil cannot be separated by gravity separation (see “TORR™—The Next Generation of Hydrocarbon Extraction From Water”, M. J. Plebon, Journal of Canadian Petroleum Technology, Vol. 43, No. 9 (September 2004) pp. 1-4). Further, such as process d₁₃, when an evaporator is applied to the softening/desalination step of the subsequent stage, scale troubles caused by organic matters in a boiler arise. Therefore, scale troubles are still remaining obstacles to advancement of these conventional methods (see “Water recycling for oil sands development”, Nobutoshi Shimizu and Tsuneta Nakamura, Journal of the Japanese Association for Petroleum Technology, Vol. 70, No. 6 (November 2005) pp. 522-525).

### SUMMARY OF THE INVENTION

The present invention resides in an apparatus of produced water treatment, to be adopted in an in-situ recovery method of producing bitumen from oil sand, the apparatus capable of removing the oil from produced water, the produced water of being left by separating the bitumen from bitumen-mixed fluid having been recovered from the oil sand, the apparatus having: a vessel for receiving the produced water; a submerge type filtration membrane module, installed in the vessel for filtering the produced water in the condition of the membrane being submerged in the produced water; a bubble generator for generating bubbles to be forwarded toward the submerged filtration membrane in the produced water.

Further, the present invention resides in a method of produced water treatment, in an in-situ recovery method of producing bitumen from oil sand, having the steps of: separating the bitumen from bitumen-mixed fluid so as to leave produced water (oil-containing water), the bitumen-mixed fluid having been recovered from the oil sand wells; introducing the produced water into a vessel, the vessel being installed with a submerged filtration membrane module therein; bringing the produced water into passing through the membrane in the condition of the membrane submerged in the produced water; simultaneously supplying bubbles to be forwarded toward the membrane in the produced water.

Other and further features and advantages of the invention will appear more fully from the following description, appropriately referring to the accompanying drawings.

### BRIEF DESCRIPTION OF THE DRAWINGS

FIG. 1 is a flow diagram schematically showing steps of treating the produced water that is obtained in production of bitumen according to one embodiment of the apparatus of produced water treatment of the present invention.

FIG. 2 is a side section view schematically shown by enlarging the apparatus of produced water treatment shown in FIG. 1.

FIG. 3 is a plane section view shown by simplifying a cross-section of the apparatus of produced water treatment shown in FIG. 2, taken along the A-A arrow line.

FIG. 4 is a flow diagram schematically showing the de-oiling steps of the produced water according to a conventional method.

FIG. 5 is a flow diagram schematically showing the softening steps of the produced water to produce boiler feed water according to conventional methods.
1 oil sand layer
2 Free water Knockout
3 Treater
4 Oil storage tank
5 Skim tank
6 Induced gas floatation
7 Oil removal filter
8 De-oiled water tank
9 Lime softener
11 Weak acid cation softener
12 Evaporator
13 Boiler feed water tank
14 Mechanical vapor compression system
15 De-oiling drum (De-oiling unit)
15a Inlet pipe
15b Skimmed oil discharge pipe
15c Overflow weir
15d Inlet nozzle
15e Vessel
16 Bubble generator (gas diffuser)
17 Filtrate suction line
18 Gas supply unit
19 Gas recycle line
20A Bitumen-mixed fluid
20B Produced water (Oil-containing water)
20C Boiler feed water
20D De-oiled water
20E Skimmed oil
51 Cooler
52 Pump
53 Gas bubble
54 Oil
55 Gas in a vessel
56 Circulation blower
60 Filtration membrane module
61 Hollow fiber type membrane

### DETAILED DESCRIPTION OF THE INVENTION

As described above, hitherto, in the SAGD process or CSS process, it is an ordinary process that after oil-water separation in the oil-containing water, and subsequent softening treatment, the treated water (de-oiled water) is supplied to the once-through type boiler. It may be prefer to apply a drum-type boiler instead of an once-through type boiler, for which the desalinated water would be produced by using an evaporator after oil-water separation, in consideration of more reduction in consumed water quantity, reduction in blow down quantity, reduction in consumed amount of chemicals, reduction in consumed amount of energy, CO₂ emission-reduction, reduction in equipment cost, and easy operation and maintenance. Further, it is earnestly desired to develop a responsible method that does not cause such the troubles as described above. Further, in view of heating at near upstream of the boiler, it is desired to perform a treatment with minimal cooling of water during the preceding oil-water separation step. If these are realized, heat loss in the entire water treatment system can be drastically reduced. For example, if a sophisticated oil-water separation is actualized at high temperature of about 120° C., the heat loss is reduced, so that a good merit of using both evaporator and drum-type boiler can be obtained. Further, it is possible to design a plant capable of responding to such a wide variety of problems as described above, which leads to a good improvement in processing efficiency, economy, and environmental issue.

In consideration of particular points to be solved relating to the above-described oil-water separation of produced water in an in-situ recovery method of producing bitumen, the present invention addresses an apparatus of produced water treatment, an oil-water separation system using the apparatus, an oil-water separation method, and a water reuse method, each of which makes it possible to realize sophisticated oil-water separation of the produced water, and also to reduce a thermal loss, with facilitated operation and maintenance, neither requiring complex multistage steps nor depending on special facilities as required in the conventional methods.

Further, the present invention addresses an apparatus of produced water treatment, an oil-water separation system using the apparatus, an oil-water separation method, and a water reuse method, each of which enables: to reduce the number of equipments and steps that are required for reuse of produced water which is produced in the production of bitumen according to an in-situ recovery method; to downsize the entire system; and to use practically a general-purpose drum-type boiler equipment that has been difficult to practically use hitherto, all of the apparatus, the system and the method being excellent from environmental and economical points of view.

(1) An apparatus of produced water treatment, to be adopted in an in-situ recovery method of producing bitumen from oil sand, the apparatus capable of removing the oil from produced water, the produced water of being left by separating the bitumen from bitumen-mixed fluid having been recovered from the oil sand, the apparatus having:

a vessel for receiving the produced water;

a submerge type filtration membrane module, installed in the vessel, for filtering the produced water in the condition of the membrane being submerged in the produced water; and

a bubble generator for generating bubbles to be forwarded toward the submerged filtration membrane in the produced water.

(2) The apparatus of produced water treatment according to the above item (1), further having a pressure regulator for reducing the pressure in the vessel so as to generate the bubbles by foaming the produced water with a dissolved gas therein, the bubbles supplied toward the filtration membrane.

(3) The apparatus of produced water treatment according to the above item (1) or (2), further having: an overflow weir inside the vessel, and a recovery unit for returning the skimmed oil overflowing from the weir so as to mix with the bitumen-mixed fluid.

(4) The apparatus of produced water treatment according to any one of the above items (1) to (3), wherein the vessel is capable of maintaining a temperature of the produced water in a range of 60° C. to 200° C., and also maintaining a pressure inside the vessel in a range of 0 to 10 kg/cm² G.

(5) The apparatus of produced water treatment according to any one of the above items (1) to (4), further having a gas circulation unit for reusing the gas in the vessel as the gas that generates bubbles.

(6) The apparatus of produced water treatment according to any one of the above items (1) to (5), wherein the submerge type filtration membrane has a hollow fiber shape or a flat sheet shape, and the outer surface of the filtration membrane is scoured with the bubbles.

(7) The apparatus of produced water treatment according to any one of the above items (1) to (6), wherein the in-situ recovery method is a SAGD (steam assisted gravity drainage) process or a CSS (cyclic steam stimulation).

(8) A water reuse system in an in-situ recovery method of producing bitumen, having:

the apparatus of produced water treatment according to any one of the above items (1) to (7),

an evaporator for distilling the de-oiled water taken from the membrane to obtain distilled water, and

a drum-type boiler for generating steam from the distilled water, the steam capable of being used for recovering the bitumen.

(9) A method of produced water treatment, in an in-situ recovery method of producing bitumen from oil sand, having the steps of:

separating the bitumen from bitumen-mixed fluid so as to leave produced water (oil-containing water), the bitumen-mixed fluid having been recovered from the oil sand wells;

introducing the produced water into a vessel, the vessel being installed with a submerge type filtration membrane module therein; and

bringing the produced water into passing through the membrane in the condition of the membrane submerged in the produced water; simultaneously

supplying bubbles to be forwarded toward the membrane in the produced water.

(10) The method of produced water treatment according to the above item (9), further comprising the step of adjusting the pressure inside the vessel so as to generate the bubbles by foaming the produced water with a gas dissolved therein, the bubbles supplied toward the filtration membrane.

(11) The method of produced water treatment according to the above item (9) or (10), wherein the produced water in the vessel is filtered while a temperature of the produced water is maintained in a range of 60° C. to 200° C.

(12) The method of produced water treatment according to any one of the above items (9) to (11), wherein the produced water in the vessel is filtered while a pressure inside the vessel is maintained in a range of 0 to 10 kg/cm² G.

(13) The method of produced water treatment according to any one of the above items (9) to (12), wherein the produced water is treated to be de-oiled water so that the de-oiled water has an oil concentration of 5 mg/liter or less.

(14) The method of produced water treatment according to any one of the above items (9) to (13), wherein the skimmed oil overflowing from the overflow weir installed in the vessel is recovered and returned so as to mix with the bitumen-mixed fluid before treatment.

(15) The method of produced water treatment according to any one of the above items (9) to (14), wherein the in-situ recovery method is a SAGD (steam assisted gravity drainage) process or a CSS (cyclic steam stimulation).

(16) A method of reusing water, adoptable in an in-situ recovery method of producing bitumen, having the steps of:

distilling the de-oiled water by an evaporator to obtain distilled water, the de-oiled water having been treated with the filtration membrane by the method of produced water treatment according to any one of the above items (9) to (15),

generating steam from the distilled water by a drum-type boiler, and

reusing the steam for recovering bitumen from the earth.

An apparatus of produced water treatment in the present invention can remove the oil from produced water which is left by separating the bitumen from bitumen-mixed fluid having been recovered from the oil sand, to be adopted in the field of an in-situ recovery method of producing bitumen from oil sand. Thus, the apparatus has: a vessel for receiving the produced water; a submerge type membrane module, installed in the vessel, for filtering the produced water in the condition of being submerged in the produced water; and a bubble generator for generating bubbles toward the submerged filtration membrane.

The method of producing bitumen from oil sands is classified into a surface mining method and an in-situ recovery method, and the oil-water separation method of the present invention is applied to the latter method. As the in-situ recovery method that is currently operated in practice, there are two methods, namely a SAGD process and a CSS process.

In a specific embodiment of the SAGD process, two horizontal wells are drilled at several meter intervals. A high-temperature steam is injected from the upper-level horizontal well (injection well). The injected steam rises while transmitting heat to the surrounding area, and forms a steam chamber until the rising of the steam stops owing to the top of an oil layer, an intervenient mudstones, and finally the heat-lost steam turns to condensed water. The condensed water and the bitumen having viscosity reduced by the transmitted heat flow to the lower-level horizontal well (production well) by gravity along the interface with the higher viscosity bitumen, and they are produced as a mixed fluid. A space is formed in the oil layer as a result of the production of bitumen. Consequently, steam can be injected successively to the space. Thus, recovery of the lowered viscosity-bitumen is continued.

In one embodiment of the CSS process, the following three steps are repeated to continue the production. (1) Steam is injected to the well for a certain period of time, and then the injection of steam is stopped and the well is closed. (2) Heat of steam is transmitted to the oil sand layer, and then the oil sand layer is left for a while, to fluidize bitumen. (3) The well is opened, and bitumen that flows into the well is pumped. These steps are repeated in one well. If only one well is used, the time period of the production of bitumen becomes intermittent. Therefore, by adjusting a timing of injection of steam and production of bitumen with respect to each group of several wells, a stabilized quantity of production can be maintained in the entire wells.

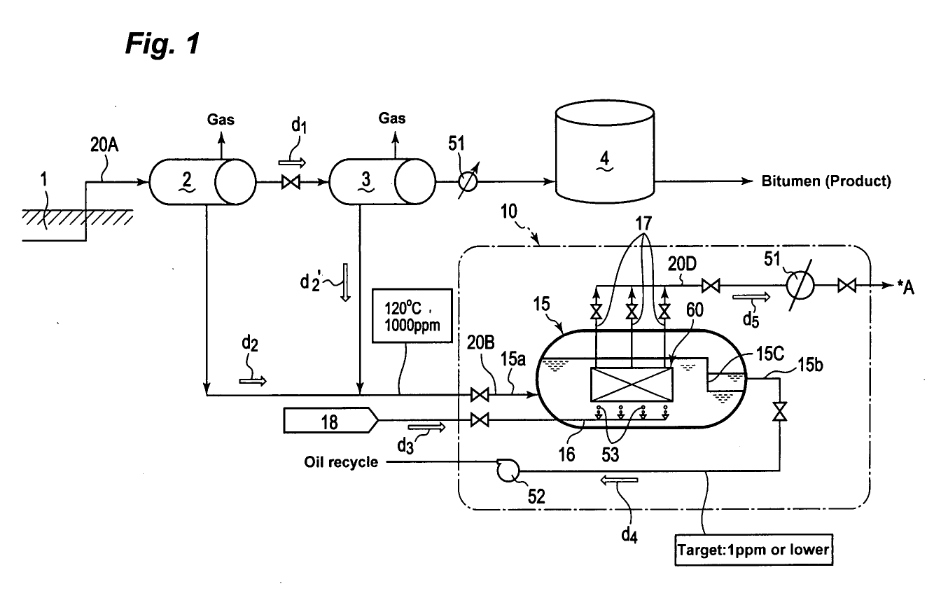

FIG. 1 is a flow diagram schematically showing steps of treating produced water that is obtained in production of bitumen according to one embodiment of the apparatus of produced water treatment of the present invention. In the SAGD process and the CSS process, a high-temperature and high-pressure steam is injected to an oil sand layer in the earth to increase fluidity of the bitumen in the oil sand layer, thereby recovering the bitumen in the earth together with a hot water, as described above. Firstly, sands, heavy metals, and the like are contained in the hot water including the thus-recovered bitumen. As the following steps are outlined above, the hot bitumen-mixed fluid is fed to a separator (a free water knockout 2 and a treater 3) and separated into a bitumen, an oil-containing water (produced water) and a process gas. The produced water thus separated is oil-contaminated water including a substantial amount of oil. Before cooling, the produced water has been heated at about 120° C. (In the present invention, the term “heated” means that the temperature is elevated higher than the ambient temperature: for example, if the ambient temperature is about 20° C., the temperature is elevated higher than the about 20° C.). The produced water is introduced to an oil-water separation unit (de-oiling drum) 15 to remove oil from the produced water. The de-oiled water is once stored in the de-oiled tank 8. From here, the produced water is treated in same steps as those in the conventional methods. As shown by the step d₁₂ in FIG. 5, the resultant de-oiled produced water may be reused as a boiler feed water (BFW) via a lime softener 9 and a weak acid cation softener (WAC) 11.

Raw water pumped from a water-well is added as a makeup-water to the de-oiled produced water 20 D. According to the present embodiment, a technique of applying the step d₁₃ using an evaporator 12 also makes it possible to realize a practical water reuse. This technique is described below.

Details of each of steps (areas) in the SAGD process are as follows.

### [Well Pad Area]

The high-pressure steam is distributed to each injection well from its header via a flow-control valve. On the other hand, in the production well, production is performed under the flow control so that steam does not break through from the injection well. Both vapor and liquid of the produced fluid from a well head separator is collected to a header, and then delivered to the oil-water separation area. An emulsification-preventing chemical is added to the liquid header.

### [Oil-Water Separation Area]

The produced mixed fluid enters into an oil separator (FWKO), and is separated into three phases of vapor (hydrocarbon, moisture, some amount of hydrogen sulfide), bitumen, and produced water. The bitumen is delivered to a treater, and dehydrated to a degree of 0.5% water content by weight. Thereafter, the bitumen is cooled with an oil cooler and then stored.

### [Oil Removal Area]

The produced water obtained from the oil-water separation area still contains the oil of 1,000 ppm, or more. The oil removal area is basically composed of a skim tank, induced gas floatation (IGF), and an oil removal filter (for example, walnut shell). The oil is removed via these equipments.

### [Water-Softening Area]

In this area, the in-plant water that is mainly composed of deoiled produced water is subjected to a treatment for reusing the treated water (de-oiled water) as the BFW (boiler feed water). Main equipments in this area are a hot or warm lime softener, an after filter, and a weak acid cation exchanger (WAC). In the lime softener, a hardness and silica are reduced. Turbidity in the lime softener treated water is removed via the after filter (pressure filter filled with anthracite). A trace of remaining calcium and magnesium ion is completely removed with the WAC. Make-up water is supplied from water well.

### [Steam Production Area]

The BFW treated by the WAC is pumped up to the steam generator after heat recovery. In the steam generator, a natural gas is used as a fuel. Herein, a 75 to 80% quality-steam (namely, gas phase of 75 to 80 wt % and liquid phase of 20 to 25 wt %) is produced. It is fed to a high pressure steam separator and the liquid is separated. The high pressure steam is delivered to the well pad area, and injected to the well. The separated liquid is flashed by depressurization and produced a low pressure steam and it is distributed to other area. The blow down water formed by the depressurization is cooled and disposed to a disposal well.

In the conventional SAGD process, the OTSG (Once-Through Steam Generator) is usually used as a steam generator. The reason why the OTSG is used is that the OTSG is operable even though a boiler feed water contains high TDS (allowable to about 20,000 ppm, while designed to 8,000 ppm). When a drum-type boiler is used, a high-quality boiler feed water is required, and therefore, for example, an evaporator is necessary.

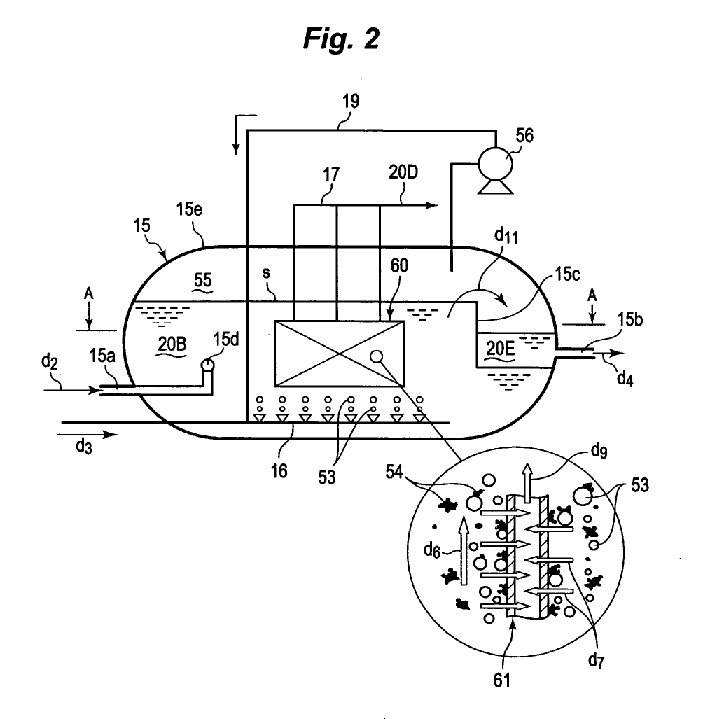

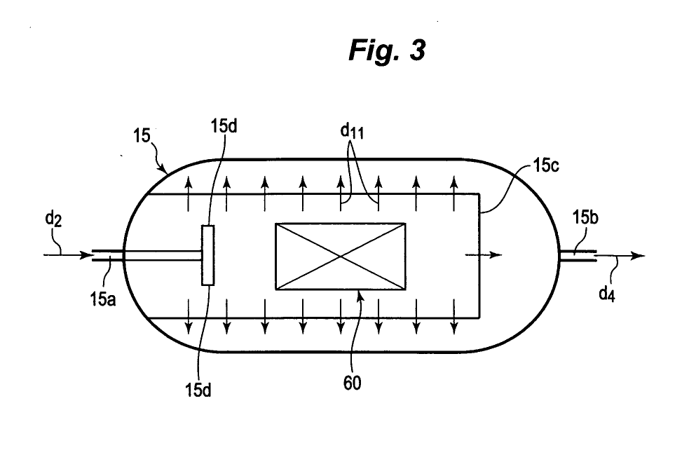

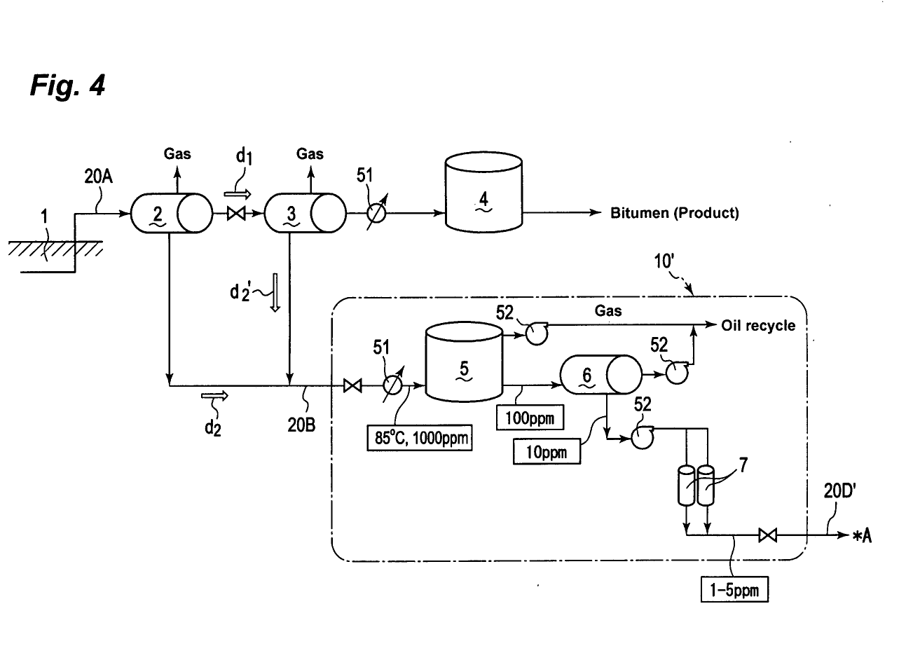

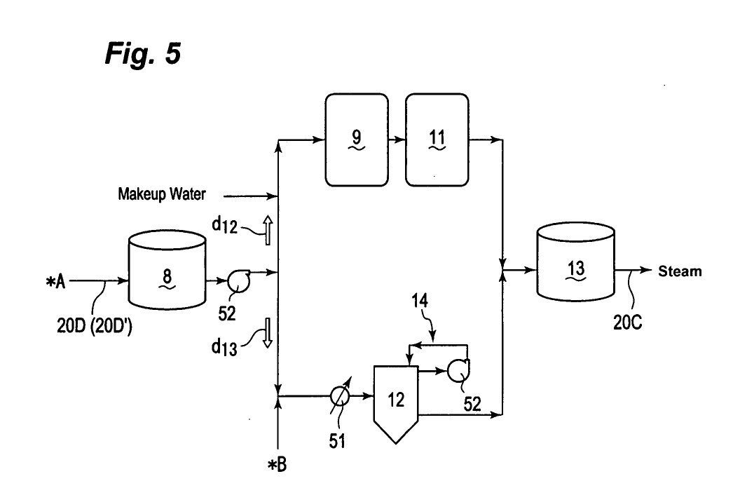

In a flow of the present embodiment, the produced water 20 B, in which a high temperature condition is maintained at about 120° C. (for example, in the range of 80° C. to 120° C.) is delivered to an oil-water separation unit (de-oiling drum) 15. Preferable embodiments of the oil-water separation unit are explained in detail below with reference to FIGS. 2 and 3. Generally, the produced water includes oil of 1000 ppm (for example, in the range of 1000 ppm to 3000 ppm). In contrast, the present invention aims to reduce the oil concentration to 1 ppm or less. This oil concentration target level is not particularly limited. However, the oil concentration is preferably controlled to 10 ppm or less, more preferably 5 ppm or less, further preferably 1 ppm or less, and especially preferably 0.1 ppm or less. According to a conventional method, a multiple-stage process including a skim tank, a IGF and ORF is required. Moreover, in the existing conditions, the oil concentration of the de-oiled water is often over 10 ppm (see M. K. Brude “High efficiency de-oiling for improved produced water quality”, IWC-06-15).

In the present embodiment, it is possible to advantageously use a polytetrafluoroethylene filtration membrane or a ceramic filtration membrane, each of which has excellent heat-resisting properties, so that the pre-cooling by a cooler 51 is not a mandatory requirement. As a result, the produced water may be delivered to an oil-water separation unit without cooling if needed. When the produced water is delivered to an evaporator located at a subsequent stage, it is preferable from a viewpoint of reduction in heat loss that, for example, separation in the oil-water separation unit 15 is performed in the range of 60° C. to 200° C., more preferably from 85° C. to 135° C., and especially preferably from 90° C. to 120° C. Further, the de-oiled water after membrane filtration may be delivered to an evaporator 12 without cooling. That is to say, though there is a cooler 51 on a flow channel shown by a de-oiled water-feeding direction d₅ in FIG. 1, the cooler may be deleted. In the area where energy consumption is increased by heating, in such a cold district like Canada, it is especially important to reduce a heat loss as mentioned above. Accordingly, reduction in the heat loss is a good advantage of the present invention.

According to the present embodiment, it is possible to favorably use the route d₁₃ in which the de-oiled water 20 D treated by the above-described oil-water separation unit 15 is directly fed to an evaporator 12 via a de-oiled water tank 8 (see FIG. 5). Further, in the de-oiled water 20 D fed to the evaporator 12, smaller sizes of oil droplets will be removed by membrane filtration compared to those obtained by conventional method. It means that organic matters which cause scaling in the evaporator have been suitably removed. Accordingly, it is not necessary to clean the evaporator frequently. Thereby, operation efficiency can be remarkably increased. Connecting *A shown in FIG. 1 with *B shown in FIG. 5, a de-oiled water 20 D after membrane filtration may be directly fed to an evaporator without passing through the de-oiled water tank. At this time, two coolers 51 shown in FIGS. 1 and 5 may be deleted as mentioned in the above embodiment. In the present invention, the term “scaling” is used to mean a scale forming that is caused by carbides originated from organic matters, or hardness such as calcium, etc.

As one of good advantages of the embodiment, it is emphasized that a drum-type boiler can be used. Previously, extremely high specialty once-through boiler has been applied by using of reused water (boiler feed water 20C) into a high-pressure and high-temperature steam that is introduced to an injection well for production of bitumen. The use of drum-type boiler makes the once-through boiler unnecessary, thereby considerably increasing cost competitiveness involved in the production of bitumen. In other words, by the use of the particular oil-water separation means described above in the embodiment, it is possible to use the evaporator practically. As a result, the produced water is synergistically purified by using the both means (i.e., oil-water separation plus evaporation) as mentioned above, and thereby extremely purified distilled water can be used as a boiler feed water 20C.

In the present invention, the water reuse treatment flow is not limited to the embodiment flow as described above, but for example, the thus-extracted de-oiled water 20D may be treated via the same equipments as in route d₁₂ (see FIG. 5). Herein, with respect to various kinds of installations and equipments for use in the present invention, ordinarily used facilities in this technical field may be used. For example, the facilities may be constructed with reference to the descriptions of “Development of Canada oilsands—Future challenges”, Kiyoshi Ogino, Journal of the Japanese Association for Petroleum Technology, Vol. 69, No. 6 (November 2004) pp. 612-620, “Water recycling for oil sands development”, Nobutoshi Shimizu and Tsuneta Nakamura, Journal of the Japanese Association for Petroleum Technology, Vol. 70, No. 6 (November 2005) pp. 522-525, and “TORR™— The Next Generation of Hydrocarbon Extraction From Water”, M. J. Plebon, Journal of Canadian Petroleum Technology, Vol. 43, No. 9 (September 2004) pp. 1-4. Specifically, the following equipments are available and applicable to the present invention: separators manufactured by NATOCO, and KVAERNER, evaporators manufactured by GE, and AQUATECH, once-through type boilers manufactured by TIW, and ATS, drum-type boilers manufactured by B&W, and C. B. NEBRASKA BOILER.

FIG. 2 is a side section view schematically shown by enlarging the apparatus of produced water treatment shown in FIG. 1. FIG. 3 is a plane section view shown by simplifying a cross-section of the apparatus of produced water treatment shown in FIG. 2, taken along the A-A arrow line. The inside of a circle in FIG. 2 is a partial section view schematically shown by enlarging the inside of a filtration membrane module 60. A submerge type filtration membrane module is installed in the apparatus of produced water treatment of the present embodiment. The terms “submerge type filtration” mean that while submerging a filtration membrane in a liquid to be filtered, the liquid is filtered so as to pass through the filtration membrane. Typically, examples of the submerge type filtration membrane include a suction filtration using a hollow fiber membrane. This filtration is performed by a technique in which while submerging a filtration membrane in a liquid, negative pressure is generated in an internal space of the hollow fiber membrane to transfer a liquid at outside of the membrane into the internal space, so that the liquid passes trough the membrane. Further, the de-oiled water may be recovered by siphoning the liquid from an internal space of the hollow fiber membrane. In order to transfer a de-oiled water 20 D to a suction line 17 in the present embodiment, a method in which the internal space of the hollow fiber membrane is sucked (direction d₉) by a pump (not shown in Figure) via the suction line 17 is applied. Alternatively, the pressure inside the pressurized vessel 15e of the oil-water separation unit (de-oiling drum) 15 may be increased so that the pressure at the side of the suction line 17 is relatively lower than the pressure inside of the pressurized vessel.

The filtration membrane is not always a hollow fiber type but may be a flat type. The term “flat type membrane” herein used is referred to as the following modules. Namely, in one module, membrane elements, in which two sets of flat sheet membranes sandwiching a spacer in between them are fixed parallel to each other, are arranged at equal spaces. In another module, pathways for water catchment are formed inside the ceramic flat plane and arranged parallel to each other. An interval between these elements of flat membrane functions as a flow channel of a raw liquid, so that filtrate water is collected through a water catchment section inside the elements of flat membrane.

As for the above-described submerge type filtration membrane and its specific operation procedure, hitherto known membranes and procedures may be used in the present embodiment. For example, the following publications can be referred for this purpose: “Mizu Jyunkan no Jidai (Era of water recirculation) Maku o riyoshita Mizu Saisei (Water reuse using membrane)” edited by Maku o riyosita shorigijyutsu kenkyu linkai, Japan Society on Water Environment (JSWE), pp. 39-49, “Jyosuimaku (Water purifying membrane)(Second Edition)” supervised by Incorporated intermediate corporation Makubunri Gijyutsu Shinkokyoukai-Makujyosui linkai, and edited by Jyosuimaku (Second Edition) editorial committee, p. 216 et seq., and JP-A-61-129094.

To the oil-water separation unit 15 of the present embodiment, produced water 20 B is fed via an inlet pipe 15a having upward nozzles (feed direction d₂). Then, the produced water fills a pressurized vessel by which an outer shell of the oil-water separation unit 15 is formed, and then the aforementioned filtration membrane module is submerged in the produced water 20 B. The filtration membrane module is connected to a suction line 17, from which filtrated de-oiled water 20 D is recovered. In this step, suction may be performed by a pump to the suction line 17, as mentioned above. In the present embodiment, however, de-oiled water 20 D can be transferred by making a pressure difference between pressure P₁ inside the pressurized vessel and pressure P₂ at the side of the suction line. The pressure P₁ inside the pressurized vessel is not particularly limited. However, the pressure is preferably set in the range of 0 to 10 Kg/cm² G, and more preferably from 2 to 5 Kg/cm² G. A difference between the pressure inside the pressurized vessel and the pressure at the side of the suction line (P₁-P₂) is preferably set in the range of 0 to 5 Kg/cm², and more preferably from 0.5 to 2 Kg/cm².

Further, the gas diffusers' 16 as a bubble generator is installed inside the oil-water separation unit 15 of the present embodiment. The gas diffusers 16 is submerged in produced water and arranged so as to lie just under the filtration membrane module 60 in the vertical direction. Further, a prescribed gas is fed to the gas diffusers from a gas supply unit such as a compressed gas cylinder etc. (feed direction d₃), thereby generating gas bubbles 53 toward the filtration membrane module. At this time, the following embodiment (not shown in FIG. 1) may be used as an alternative. That is, the gas 55 in the pressurized vessel may be recovered and circulated via a circulation blower 56 (gas circulation unit: circulation blower 56 and gas recycle line 19) to feed again the gas in the gas diffuser 16, thereby generating gas bubbles 53 inside the produced water, as shown in FIG. 2.

The state in which the bubble acts on a filtration membrane is described with reference to the enlarged illustration shown in a circle of FIG. 2. Inside the filtration membrane module 60 of the present embodiment, a number of hollow fiber membranes are set so that the hollow fiber membranes are aligned in a vertical direction. The bubble 53 generated in the liquid rises in produced water 20 B toward the direction d₆ against gravitational force. At this time, oil 54 existing in the produced water as well as the bubble tends to rise because the oil has lower density than water. However, among oils, there are ones having somewhat high in the specific gravity or being emulsified in the form of fine droplets, and thus some are dispersed in the liquid. The gas bubble 53 functions to adsorb such dispersed oil 54 and to raise the oil toward the liquid surface s rapidly. Further, since a gas bubble 53 is generated toward the filtration membrane 61 in the present embodiment, the gas bubble has a function of scouring the oil adsorbed on a surface of a filtration membrane during filtration from the surface of the membrane, and raising the oil toward the liquid surface s in the same manner as mentioned above. Combined with these functions, even if filtration of the produced water is continuously carried out by a filtration membrane 61, the membrane surface can be kept in a clean condition. Consequently, good properties of filtration can be maintained and effective recovery of filtrate effluent as described below can be realized.

The component of the gas bubble is not particularly limited, but a nitrogen gas or a natural gas is preferable. At this time, in the present invention, the pressure P₁ inside the pressurized de-oiling drum may be set lower than the pressure P₃ of produced water fed to the pressurized de-oiling drum so that the gas dissolved in the produced water 20 B can be foamed using a differential pressure (P₃-P₁) and the generated foam can be used as the gas bubble 53. Examples of these foaming materials include a natural gas contained in the produced water. The differential pressure (P₃-P₁) is not particularly limited, but it is preferable to set the differential pressure so as to be from 0 to 5 Kg/cm², and more preferably from 1 to 3 Kg/cm². The supply quantity of gas bubbles is not particularly limited and significantly varies depending on the amount of the produced water to be treated and the membrane surface area. In consideration of both scouring function of the membrane and rising function of the oil, it is preferable in the typical setting that the supply of the gas is in the range of 0 to 10 N lit/min/m² and more preferably from 2 to 5 N lit/min/m². As for the constitutional gas of the bubble, it is preferable not to use oxygen in order to prevent a fire from occurring due to contact with organic compounds in the de-oiling drum and to prevent a metal portion from corrosion.

The constitutional material of a hollow fiber membrane 61 is not particularly limited. In consideration of heat resistance, examples of the material include the aforementioned PTFE (polytetrafluoroethylene) membrane. Examples of the flat sheet filtration membrane include a ceramic membrane in addition to the PTFE membrane. Especially in the present invention, it is preferable to use a PTFE membrane as a filtration membrane from the viewpoints of good handling and easy maintenance arising from reduced weight, or the like. With respect to this point, there is a proposal to conduct oil-water separation by using a hollow tube made of porous materials and utilizing a hydrophilic/hydrophobic property of the same (see JP-A-2004-141753, JP-A-2007-185599). However, there is no description about the possibility of oil-water separation of produced water after extraction of bitumen containing heavy oil. In stead, the use of a filtration membrane made of a synthetic polymer in oil-water separation of the produced water has been avoided hitherto (see “Maku no Rekka to Fouling Taisaku” (Degradation of Membrane and Countermeasures to Fouling), NTS (2008), “Water recycling for oil sands development”, Nobutoshi Shimizu and Tsuneta Nakamura, Journal of the Japanese Association for Petroleum Technology, Vol. 70, No. 6 (November 2005) pp. 522-525). The pore size of the filtration membrane is not particularly limited. In consideration of both efficiency and flux of filtration, however, the pore size is preferably in the range of 0.01 to 1 μm, and more preferably from 0.1 to 0.5 μm. With respect to the shape of hollow fiber membrane, the diameter (outside diameter) of internal space is not particularly limited. In consideration of suction capacity, however, it is preferable to set the diameter in the range of 1 to 4 mm, and more preferably from 1 to 2 mm. The thickness of the filtration membrane is not particularly limited either. In consideration of both efficiency and flux of filtration in the same manner as described above, it is preferable to set the thickness in the range of 0.5 to 1.5 mm, and more preferably from 0.5 to 1 mm.

In an oil-water separation unit of the preset embodiment, a overflow weir 15c is also installed inside the unit. The aforementioned produced water is filled inside the vessel 15 and subjected to a membrane filtration. Further according to the preset embodiment, oil accompanied with a gas bubble is raised toward a liquid surface s in addition to a gravitational natural rising of oil, as mentioned above. By this action, the produced water 20 B inside the vessel 15 has a higher oil concentration in the surface side of the liquid, namely the oil concentration of the upside in the vertical direction is higher than that of the downside. On the other hand, the produced water is continuously fed into the vessel from an inlet pipe 15a. As a result, excessive amounts of the produced water 20 B flows over the weir 15c to an outward direction from the weir (see direction d₁₁). Thus, a skimmed oil 20E having a high oil concentration transfers from a center of the vessel to a circumference of the vessel via the overflow weir, so that the skimmed oil is separated to be recovered from a skimmed oil discharge pipe 15b (see direction d₄). For example, the recovered skimmed oil is returned to a free water knockout 2 (return unit: a return pump 52 and a skimmed oil discharge pipe 15b). The height of the overflow weir 15c is not particularly limited. However, it is preferable that the overflow weir level is as high as the height of a filtration membrane module 60 being submerged sufficiently in the produced water. The supply flow rate of the produced water to a vessel is not particularly limited and depends on the size of the vessel and the like. It is preferable in a typical setting that the supply rate is in the range of 10 to 200 m³/hr and more preferably from 50 to 100 m³/hr. In consideration of application to an in-situ recovery method, it is also preferable to use a pressurized vessel having a size of about 5 m³ to about 200 m³.

As described above, a detailed explanation based on the figures has been made about preferred embodiments of the present invention and both function and advantages achieved by the embodiments. More described about problems of a conventional oil-water separation method, in the oil-water separation method proposed and used in practice hitherto, a number of equipments are necessary, which makes the method complicated and high plant cost, and further makes operation management difficult. Especially, since the produced water is ordinarily heated at a high temperature of 120 to 130° C., it is necessary for once to lower the temperature to the range of 80 to 85° C. using a heat exchanger in the conventional oil-water separation method. However, the heat exchanger is necessary to be cleaned frequently in order to prevent fouling problems. This is one of the reasons to decrease the rate of operation. The apparatuses and the methods according to a preferable embodiment of the present invention make it possible to address to these problems.

Recently, application of a ceramic membrane in an internal pressure type cross flow is under consideration for the oil-water separation method. In this method, it is necessary to maintain a linear velocity on the membrane surface at a high level in order to prevent fouling problems. As a result, circulation at a follow rate about five times as high as a quantity of de-oiled water is required. In order to overcome this problem, a very big circulation pump and a big header pipe are necessary, which causes a problem for increase in not only an equipment cost, but also an operation cost such as power consumption, and possibly becomes an impediment to a practical (commercial) application. Further when a cross flow filtration is used, concentrations of oil and suspended solids are increased in circulating water. For example, if the blow-down quantity is 5%, an oil concentration in a circulating water increases 20 times. Specifically, if oil content of the feed liquid is 1,000 ppm, the oil content in the circulating water is 20,000 ppm. It is assumed that reduction of oil content in a filtrate to 10 ppm or less that is a targeted level becomes difficult. According to a preferable embodiment of the present invention, such excess concentration in the filtration system as described above is not occurred, and it is possible to suitably address to a supply of de-oiled water having extremely lowered oil concentration without excess equipments and increase of operation cost.

According the present invention, when performing oil-water separation of a produced water that is left in production of bitumen according to an in-situ recovery method, it is possible to realize a sophisticated oil-water separation of the produced water and to reduce heat loss, neither depending on a number of multi-stage troublesome steps nor requiring particular equipments that have been required in the conventional method, and facilitated operation and maintenance.

Further, according to the present invention, it is possible to reduce the number of equipments and steps that have been required for reuse of the produced water that is produced in the production of bitumen according to the in-situ recovery method. Thus, the present invention can achieves downsizing of the entire system, and employment a drum-type boiler that has been difficult to use hitherto, and further can realize oil-water separation and water reuse treatment that are excellent from environmental and economical points of view.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2009-239857 filed in Japan on Oct. 16, 2010, which is entirely herein incorporated by reference.

1. An apparatus of produced water treatment, to be adopted in an in-situ recovery method of producing bitumen from oil sand, the apparatus capable of removing the oil from produced water, the produced water of being left by separating the bitumen from bitumen-mixed fluid having been recovered from the oil sand, said apparatus comprising:
a vessel for receiving the produced water;
a submerge type filtration membrane module, installed in the vessel, for filtering the produced water in the condition of the membrane being submerged in the produced water; and
a bubble generator for generating bubbles to be forwarded toward the submerged filtration membrane in the produced water.

2. The apparatus of produced water treatment according to claim 1, further comprising a pressure regulator for reducing the pressure in the vessel so as to generate the bubbles by foaming the produced water with a dissolved gas therein, the bubbles supplied toward the filtration membrane.

3. The apparatus of produced water treatment according to claim 1, further comprising: an overflow weir inside the vessel; and a recovery unit for returning the skimmed oil overflowing from the weir so as to mix with the bitumen-mixed fluid.

4. The apparatus of produced water treatment according to claim 1, wherein the vessel is capable of maintaining a temperature of the produced water in a range of 60° C. to 200° C., and also maintaining a pressure inside the vessel in a range of 0 to 10 kg/cm² G.

5. The apparatus of produced water treatment according to claim 1, further comprising a gas circulation unit for reusing the gas in the vessel as the gas that generates bubbles.

6. The apparatus of produced water treatment according to claim 1, wherein the submerge type filtration membrane has a hollow fiber shape or a flat shape, and the outer surface of the filtration membrane is scoured with the bubbles.

7. The apparatus of produced water treatment according to claim 1, wherein the in-situ recovery method is a SAGD (steam assisted gravity drainage) process or a CSS (cyclic steam stimulation).

8. A water reuse system in an in-situ recovery method of producing bitumen, comprising:
the apparatus of produced water treatment according to claim 1,
an evaporator for distilling the de-oiled water taken from the membrane to obtain distilled water and
a drum-type boiler for generating steam from the distilled water, the steam being capable of using for recovering the bitumen.

9. A method of produced water treatment, in an in-situ recovery method of producing bitumen from oil sand, comprising the steps of:
separating the bitumen from bitumen-mixed fluid so as to leave produced water, the bitumen-mixed fluid having been recovered from the oil sand wells;
introducing the produced water into a vessel, the vessel being installed with an submerge type filtration membrane module therein; and
bringing the produced water into passing through the membrane in the condition of the membrane submerged in the produced water; simultaneously
supplying bubbles to be forwarded toward the membrane in the produced water.

10. The method of produced water treatment according to claim 9, further comprising the step of adjusting the pressure inside the vessel so as to generate the bubbles by foaming the produced water with a gas dissolved therein, the bubbles supplied toward the filtration membrane.

11. The method of produced water treatment according to claim 9, wherein the produced water in the vessel is filtered while a temperature of the produced water is maintained in a range of 60° C. to 200° C.

12. The method of produced water treatment according to claim 9, wherein the produced water in the vessel is filtered while a pressure inside the vessel is maintained in a range of 0 to 10 kg/cm² G.

13. The method of produced water treatment according to claim 9, wherein the produced water is treated to be de-oiled water so that the de-oiled water has an oil concentration of 5 mg/liter or less.

14. The method of produced water treatment according to claim 9, wherein the skimmed oil overflowing from the overflow weir installed in the vessel is recovered and returned so as to mix with the bitumen-mixed fluid before treatment.

15. The method of produced water treatment according to claim 9, wherein the in-situ recovery method is a SAGD (steam assisted gravity drainage) process or a CSS (cyclic steam stimulation).

16. A method of reusing water, adoptable in an in-situ recovery method of producing bitumen, comprising the steps of:
distilling the de-oiled water by an evaporator to obtain distilled water, the de-oiled water having been treated with the filtration membrane by the method of produced water treatment according to claim 9,
generating steam from the distilled water by a drum-type boiler, and
reusing the steam for recovering bitumen from the earth.
